(19) United States
(12) Patent Application Publication
(10) Pub. No.: US 2010/0289904 A1
(43) Pub. Date: Nov. 18, 2010

(54) VIDEO CAPTURE DEVICE PROVIDING MULTIPLE RESOLUTION VIDEO FEEDS

(75) Inventors: Cha Zhang, Sammamish, WA (US); Zhengyou Zhang, Bellevue, WA (US); Zicheng Liu, Bellevue, WA (US); Wanghong Yuan, Sammamish, WA (US); Christian Huitema, Clyde Hill, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/466,494

(22) Filed: May 15, 2009

(51) Int. Cl. H04N 7/08; H04N 7/24; H04N 5/225

(52) U.S. Cl. 348/207.1; 375/E07.024; 348/384.1; 348/E07.024; 348/E05.025

(57) ABSTRACT

Systems are disclosed that provide improved transfer speed of video data from a video capture device to a computing device using multiple video feeds respectively comprising different resolutions. A high-resolution image sensor is used to convert light images into a high-resolution video data stream. A down sampler converts the high-resolution video data stream to a low-resolution video data stream, so that both a low-resolution data stream and a high-resolution data stream are available. While the low resolution-data stream can be sent to the computing device, a digital signal processor (DSP) processes the high-resolution video data stream in accordance with an input control signal that is comprised of desired high-resolution video stream parameters derived from the low-resolution video data stream.

### BACKGROUND

Modern video camera sensors are capable of capturing video with very high resolution (e.g., above a four million pixel rate per video image). In fact, many modern video cameras are capable of high definition video capture. Often, video cameras are used in conjunction with a computer (e.g., as a webcam, or surveillance camera) to capture and stream live video to the computer's monitor. A common use for live video streaming is video conferencing or video chatting over a connection between two or more computers (e.g., over the Internet or an intranet). Often, during video conferencing, a user may wish to have a detailed view of an area within the imaging range of the video camera. For example, during a video conference between business colleagues, one may wish to view writing on a whiteboard that is within view of the camera, or to view details of an object, or even to track the face of an individual as they move around the video capture area.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Despite advances in video capture resolution, webcams and other video cameras that are connected to a computer (e.g., by Firewire or USB cable) are typically limited in their video streaming ability. For example, where a video camera may be able to capture a resolution of over four million pixels, a webcam may merely be able to stream a resolution of less than two million pixels. A main cause for the reduced resolution of the live streaming video is caused by the connection from the video capture device to the computing device.

For example, current USB 2.0 protocols can “theoretically” support a four hundred and eighty mega-byte per second (Mbps) transfer rate, but the actual transfer rate is typically around three hundred Mbps. In order to achieve higher transfer rates of higher resolution streaming video, current technologies include compressing images (e.g., using MJPG) before sending them to the computer, sampling some of the color channels at a lower rate of bits, or dropping a frame rate to reduce the raw data. However, each of these compromises video quality, and may increase processing requirements of the computer.

Further, although higher bandwidth connections are on the horizon or currently available, such as IEEE protocol 1394b and USB 3.0, it appears that advances in camera sensor resolution are typically faster than advances in connection transfer rates (e.g., the resolution of the camera increases before technology becomes available that can transfer the images at an appropriate rate). High-resolution video may not always be necessary for most applications that utilize live video streaming. However, using a combination of high and low-resolution video may be able to alleviate a transfer bottleneck, where merely a portion of the full video is transferred in high-resolution.

Systems are disclosed that provide an architecture for high-resolution video capture devices (e.g., cameras) that allow an application using the streaming video to have a flexible approach to which part of a video will be used in high-resolution, while using a low-resolution video for most functions. In this way, for example, the connection between the video capture device and the computing device may be able to transmit both a high-resolution data stream and a low-resolution data stream, where the combined amount of data meets the bandwidth of the connection.

In one embodiment, in order to provide improved transfer speed of video data from a video capture device to a computing device using multiple video feeds respectively comprising different resolutions, a high-resolution image sensor is used to convert light images into a high-resolution video data stream. The high resolution sensor can be targeted by a lens in the camera, directing light to the sensor. A down sampler can convert the high-resolution video data stream to a low-resolution video data stream, for example, thereby having both a low-resolution data stream and a high-resolution data stream. While the low resolution-data stream can be sent to the computing device, for example, the high resolution data stream can go to a digital signal processor (DSP), which can process the high-resolution video data stream in accordance with an input control signal that is comprised of desired high-resolution video stream parameters derived from the low-resolution video data stream. The input control signal may come from an input control signal generator that generates the signal in accordance with the desired high-resolution video stream parameters, such as a cropping window and image enhancements (e.g., brightness, contrast, etc.)

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary use of a video capture device connected to a computing device.

FIG. 2 is a component block diagram of an exemplary system for providing improved transfer speed of video data from a video capture device to a computing device using multiple video feeds respectively comprising different resolutions.

FIG. 3 is a component block diagram of an exemplary alternate embodiment of one or more systems described herein.

FIG. 4 is a component block diagram of an exemplary portion of a system where an input control signal generator may be disposed on a computing device.

FIG. 5 is a component block diagram of alternate embodiment of an exemplary system for providing improved transfer speed of video data from a video capture device to a computing device using multiple video feeds respectively comprising different resolutions.

FIG. 6 is a component block diagram of an exemplary alternate embodiment of one or more systems described herein.

FIG. 7 is a component block diagram of one embodiment of a portion of an exemplary system, where an input control signal generator is disposed on a video capture device.

FIG. 8 is an illustration of an exemplary environment where the systems described herein may be used.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

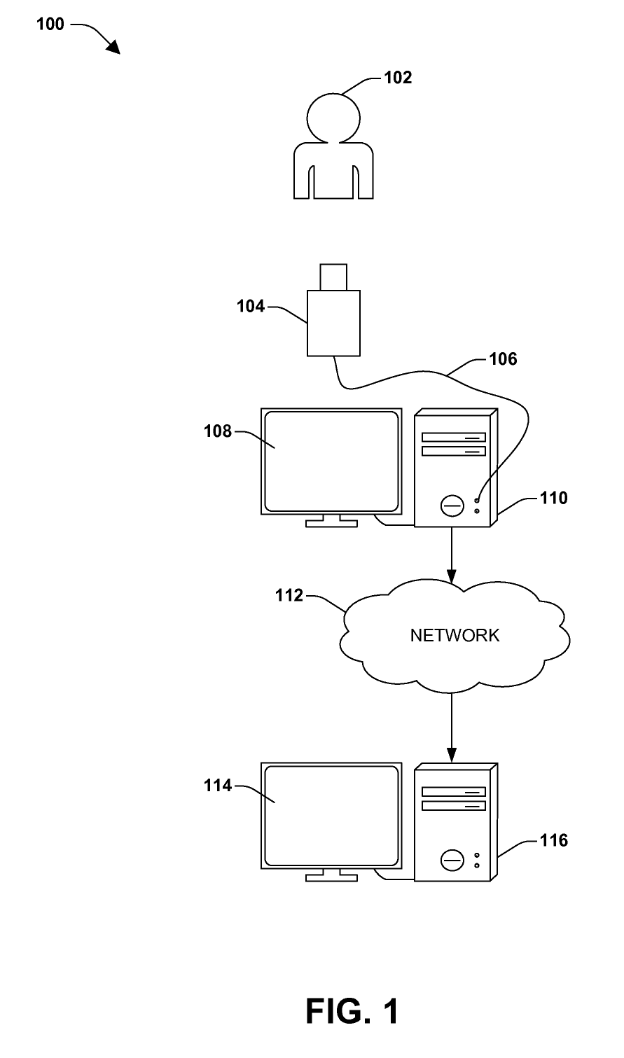

FIG. 1 is an illustration of an exemplary embodiment 100 where a video capture device 104, such as a video camera, is used to capture live streaming video, such as for a video conference or chat. For example, a group of people may engage in a video conference, where one part of the group is located remotely from the other. In this example, a video camera or webcam 104 can be attached to a computing device, such as a desktop or laptop computer 110, using a connection 106, such as a USB or Firewire cable.

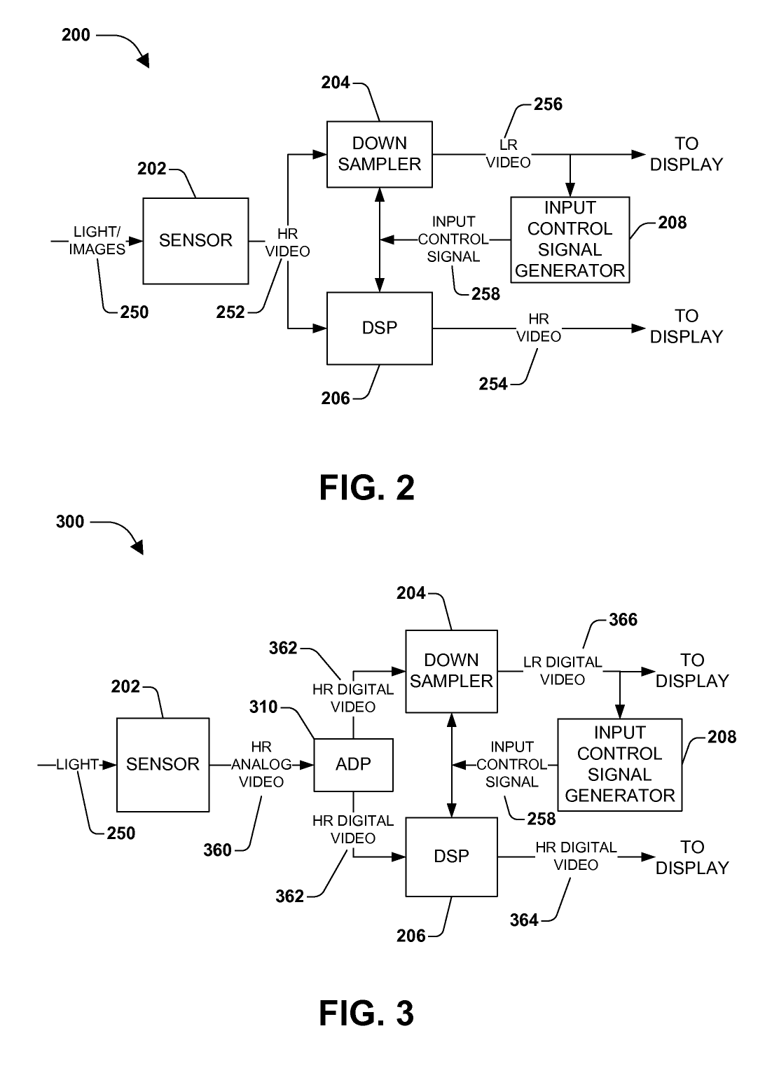

Typically, a depiction of the subject 102 captured by the camera 104 can be displayed on a monitor 108. Further, in one embodiment, the local computer 110 can be connected to a network, such as an intranet or the Internet, which connects to a remote computer 116. A streaming video of the subject 102 can then be displayed on the remote computer's monitor 114, for example, for viewing the remote part of the group of people in the video conference. During this type of video streaming, for example, a portion of imaging area captured by the camera 104 may be of particular interest to those viewing the video, such as a particular object, an individual face, or writing on a whiteboard. In this example, it may be desirable to view a close up detail of the region of interest (ROI).

Where high resolution video may be desired, such as for a video conference where detailed objects or whiteboard details may be displayed, a system may be devised that provides for improved transfer speed of a live video feed from a web-cam, for example, to a desktop computer with a display monitor. FIG. 2 is a component block diagram of an exemplary system 200 for providing improved transfer speed of video data from a video capture device to a computing device using multiple video feeds respectively comprising different resolutions.

Light-based images 250 are directed toward a high-resolution image sensor 202, such as a charge-coupled device (CCD) or a complimentary metal-oxide semiconductor (CMOS). For example, the sensor 202 may have light directed by a camera lens that is collecting live images. The sensor 202 is configured to convert light images into a high-resolution video data stream, and the high-resolution video data stream 252 is sent from the sensor 202 to both a down sampler 204 and a digital signal processor 206 (DSP).

The down sampler 204 is configured to convert the high-resolution video data stream 252 to a low-resolution video data stream 256. The DSP 206 is configured to process the high-resolution video data stream 252 in accordance with an input control signal 258, to produce a processed high-resolution video data stream 254. The input control signal 258 comprises desired high-resolution video stream parameters derived from the low-resolution video data stream 256. In one embodiment, the input control signal can be generated by an input control signal generator 208, which may be disposed on the video capture device, or on an attached computing device, for example.

In one embodiment, such as in the exemplary embodiment 300, of FIG. 3, the sensor 202 may output an analog video data stream 360, such as electric voltage pulses from a CCD. In this embodiment, an analog to digital processor 310 (ADP) may be configured to convert the high-resolution analog video data stream 360 to a high-resolution digital video data stream 362. Further, the down sampler 204 and the DSP 206 can be configured to output digital video data streams 366 and 364 respectively.

In another embodiment, the ADP 310 may be disposed on the high-resolution image sensor 202. For example, the high-resolution image sensor 202 may comprise an ADP such that an analog data is converted to digital data prior to being output from the high-resolution image sensor 202 as a high-resolution digital video stream 362.

In another embodiment, the ADP 310 may be disposed on the DSP 206. For example, the high-resolution image sensor 202 may output an analog video data stream to the DSP 206. In this example, prior to signal processing based on the input control signal 258, where the ADP 310 is disposed on the DSP 206, the analog data stream can be converted to a digital data stream. Further, in one embodiment, the down sampler 204 disposed on the DSP 206, such that the high-resolution video data stream 252 or 362 can be converted to a low resolution data stream 256 or 366 by the DSP 206.

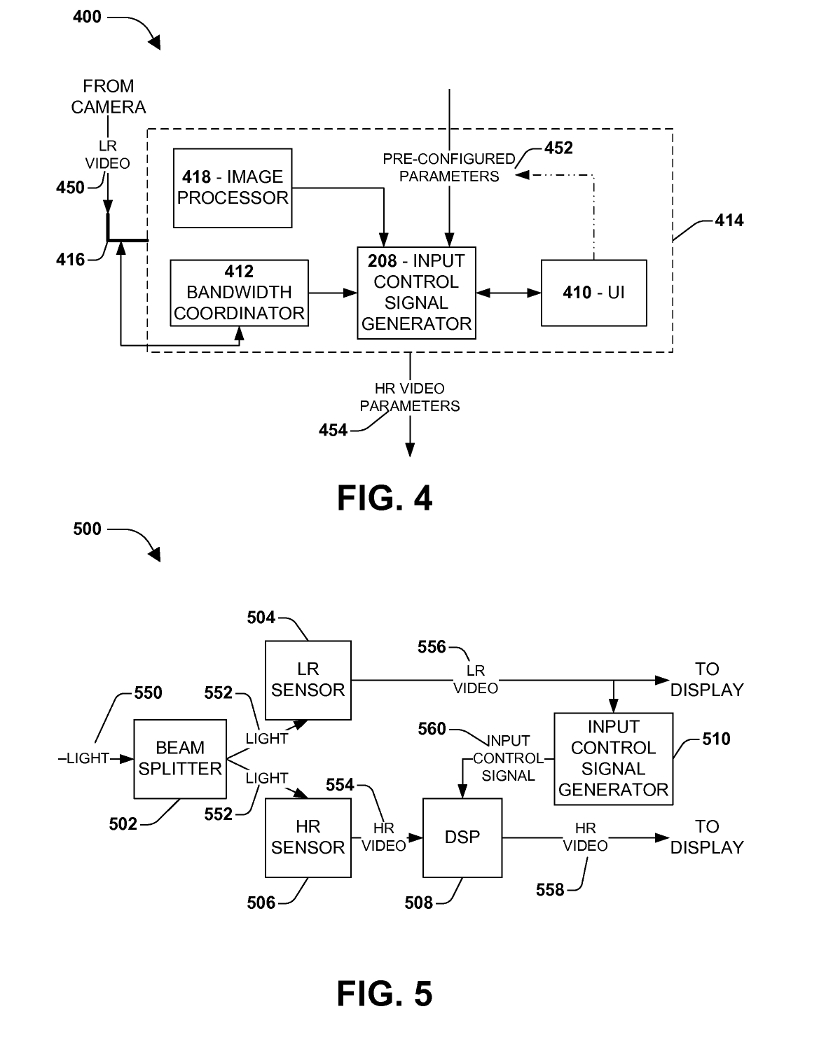

FIG. 4 is a component block diagram of an exemplary portion of a system 400 where an input control signal generator 208 may be disposed on the computing device 414. In this embodiment 400, the input control signal generator 208 can be configured to analyze the low-resolution video data stream 450, and provide desired high-resolution video stream parameters 454.

In one embodiment, the desired high-resolution video stream parameters 454 can be based on pre-configured parameters 452, which may be set for the input control signal generator 208, for example. For example, the pre-configured parameters 452 may comprise a set of parameters devised to adjust images in the video in accordance with desired, pre-defined image conditions, such as image brightness, gain control, exposure control, white balance, and other image adjustment qualities. Further, the pre-configured parameters may comprise cropping parameters for the video, for example, that automatically crop the video images in accordance with pre-defined criteria, such as tracking an object, facial recognition, and other image detail parameters.

In another embodiment, an image processing component 418 can be operably coupled to the input control signal generator 208, and configured to analyze the low-resolution video data stream 450 to determine image enhancement parameters for the high-resolution video stream, for example, for the high-resolution video parameters 454 that are incorporated into the input control signal (e.g., as in FIGS. 2 & 3, 258). As an example, the image processing component 418 can automatically determine appropriate image qualities for the high-resolution video, based on an analysis of the low-resolution video 450. Image enhancement may include, but is not limited to, image quality, resolution, cropping, noise removal, orientation, perspective correction, sharpening/softening, color adjustment, and special effects.

In another embodiment, a user interface 410 (UI) can be operably coupled to the input control signal generator 208. The UI 410 can be configured to allow a user to configure parameters for the high-resolution video stream. For example, a user may wish to crop a particular portion of the video, such as details on a whiteboard during a video conference, and can use the UI 410 to configure the cropping parameters for the video (e.g., by creating a cropping window in an image from the video). The UI 410 can also be used to adjust the image quality of the video, for example, and may be configured to input or adjust the pre-configured parameters 452. Additionally, the UI 410 may be coupled with the image processing component 418, for example, to allow a user to select desired enhancements as default settings, and/or to allow an automatic adjustment based on appropriate image conditions.

In another embodiment, a bandwidth coordination component 412 can be operably coupled to the input control signal generator 208, and configured to identify a bandwidth of data transfer between the video capture device and the computing device over the connection 416, such as a firewire or universal serial bus (USB) cable. Further, bandwidth coordination component 412 can determine high-resolution video stream parameters 454 that facilitate transferring a high-resolution video stream region of interest (ROI) to the computing device in accordance with the identified bandwidth.

For example, a user or the image processor 418 may identify a ROI in the low-resolution video 450 that they desire to view as a high-resolution video, such as a person and/or an object detail. The ROI and corresponding cropping parameters can be identified, and the bandwidth coordination component 412 may determine appropriate high-resolution video stream parameters 454 based on the desired ROI size and resolution, in conjunction with the identified bandwidth of the connection 416.

In this way, as seen in FIGS. 2 & 3, the input control signal 258 sent to the DSP 206 can help determine which portion 254, 364 of the high-resolution video stream 252, 362 will be sent to the display, and at which resolution. Therefore, the bandwidth coordination component 412 can facilitate sending both the low-resolution video stream 256, 366 and the high-resolution video stream 254, 364 to the computing over the connection 416, at a same time, for example, by adjusting the high-resolution video parameters 454 to meet the bandwidth of the connection 416.

In another embodiment, the input control signal generator 208 may be disposed on the video capture device. Further, one or all of the components in the exemplary embodiment 400 of FIG. 4 may be disposed on the video capture device. In this embodiment, the connection between the video capture device and the computing device 414 may be utilized to merely transfer the dual video stream, comprising both high and low resolution video.

It will be appreciated that the systems described herein are not limited to the embodiments described above, describing locations for components in the exemplary system. It is anticipated that those skilled in the art may devise alternate arrangements for the components. For example, the UI 410 may be disposed on the computing device 414, while the remaining components are disposed on the video capture device. Further, the components may be arranged between the video capture device and the computing device in a manner that provides for desired transfer speeds in coordination with desired processing speeds. Additionally, the input control signal generator may be disposed on the video capture device or the attached computing device.

An alternate system may be devised for providing improved transfer speed of video data from a video capture device to a computing device using multiple video feeds respectively comprising different resolutions, such as in the exemplary system 500, of FIG. 5. A light beam splitter 502 is configured to divide an incoming light beam 550 into two or more fractions 552 of the incoming light beam 550. For example, a camera lens may capture light images and direct the light images to the light beam splitter 502, which divides the light 550 into two halves 552 respectively comprising the images captured by the camera lens.

A high-resolution sensor 506 and a low-resolution sensor 504 respectively receive light 552 from the beam splitter 502. The high-resolution image sensor 506 is configured to convert light images 552 from the beam splitter 502 into a high-resolution video data stream 554, while the low-resolution image sensor 504 is configured to convert light images 552 from the beam splitter 502 into a low-resolution video data stream 556. In one embodiment, the low-resolution video data stream 556 can be sent to a display, such as on the connected computing device.

A digital signal processor (DSP) 508 is configured to process the high-resolution video data stream 554 in accordance with an input control signal 560 that comprises video stream parameters for adjusting the high-resolution video data stream 554, for example. In one embodiment, the low-resolution video data stream 556 may be sent to an input control signal generator 510, which can be configured to generate the input control signal 560 in accordance with desired high-resolution video stream parameters derived from the low-resolution video data stream 556. The input control signal generator 510 may be disposed on the video capture device or the attached computing device, for example.

In one embodiment, the DSP 508 generates a processed high-resolution video stream 558, which can be sent to a display, such as on the connected computing device. In this embodiment, for example, both the low-resolution video stream 556, which comprises a full view of the images captured by the camera lens in low resolution, and the processed high-resolution video stream, which can comprise a cropped, enhanced version of the full view of the images captured by the camera lens in high resolution, can be sent over a connection (e.g., USB or Firewire) to the computing device.

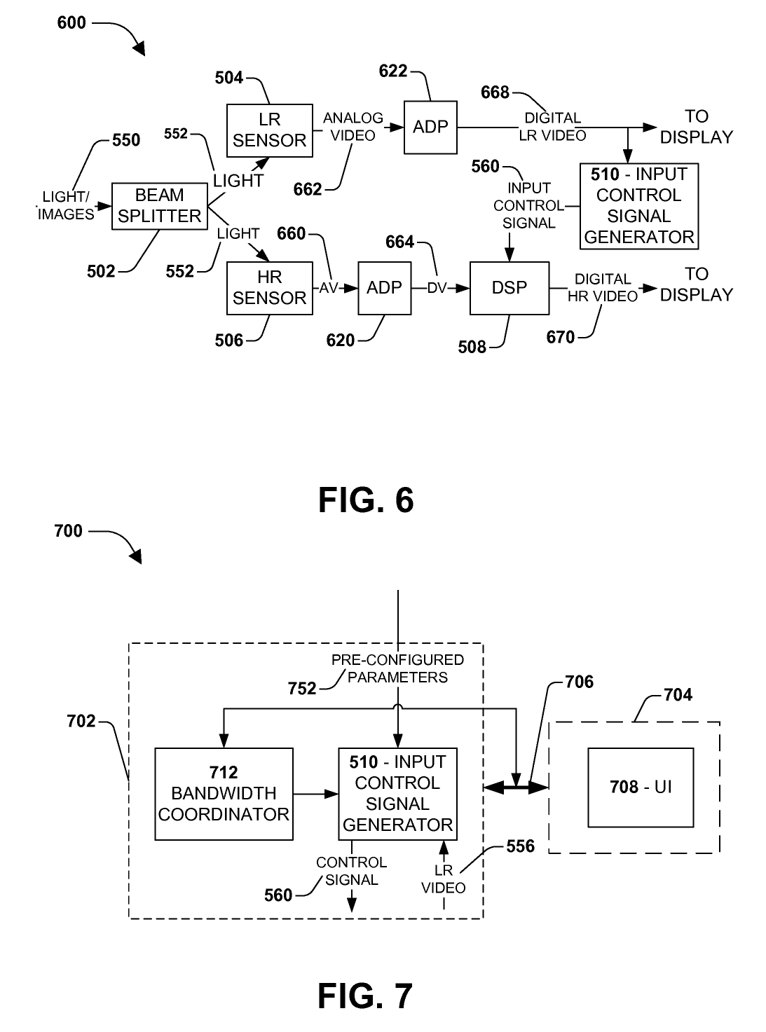

In another embodiment, as shown in the exemplary system 600 of FIG. 6, one or more analog to digital processors (ADPs) can be configured to convert an analog video data stream to a digital video data stream. In FIG. 6, the low-resolution sensor 504 and high-resolution sensor 506 may be configured to convert light images 552 into an analog video data stream 662 and 660 respectively. In this embodiment, the ADPs 662 and 620 can convert the analog video data stream 662 and 660 into a digital video data stream 668 and 664.

In another embodiment, the ADP 622 may be disposed on the low-resolution image sensor 504, and/or the ADP 620 may be disposed on the high-resolution image sensor 506. Further, in one embodiment, an ADP may be disposed on the DSP 508. In these embodiments, for example, the component that comprise the ADP can process the analog signal to a digital signal, such as after converting the light to an analog signal by the sensors 504 and 506, and/or before processing the high-resolution video for the DSP 508.

In one embodiment, the image sensors 504 and 506 may comprise a charge-coupled device (CCD) and/or a complimentary metal-oxide semiconductor (CMOS). For example, both image sensors may be CCDs, or both image sensors may be CMOSs, or one sensor may be a CCD while the other is a CMOS.

FIG. 7 is a component block diagram of one embodiment 700 of a portion of the exemplary system, where the input control signal generator 208 is disposed on the video capture device 702, such as a video camera. The input control signal generator 208 can be configured to analyze the low-resolution video data stream 556, and provide desired high-resolution video stream parameters that are incorporated into the input control signal 560 (e.g., sent to the DSP 508). In one embodiment, the desired high-resolution video stream parameters can be based on pre-configured parameters 752, such as set up by a user or default parameters for image configuration.

In another embodiment, the desired high-resolution video stream parameters can be based on a user interface 708 (UI) operably coupled to the input control signal generator 510 and configured to allow a user to configure parameters for the high-resolution video stream, such as 558 in FIG. 5. In this embodiment, the UI 708 is disposed on the computing device 704, which is connected to the video capture device 702 using a connection 706 having limited bandwidth. For example, a user may use the UI 708 to select a region of interest (ROI) in the low-resolution video, and create cropping window parameters for the ROI. Additionally, the UI 704 may comprise functionality that allows the user to enhance the video by selecting image adjustments, for example, in order to adjust the video to the users desired viewing parameters.

In another embodiment, a bandwidth coordination component 712 is disposed on the video capture device and operably coupled to the input control signal generator 510. The bandwidth coordination component 712 can be configured to identify a bandwidth of data transfer between the video capture device and the computing device, such as over the connection 706, and determine high-resolution video stream parameters that facilitate transferring a high-resolution video stream ROI to the computing device 704 in accordance with the identified bandwidth.

Additionally, an image processing component may be disposed on either the video capture device 702 or the computing device 704, and operably coupled to the input control signal generator 510. The image processing component can be configured to analyze the low-resolution video data stream 556 to determine image enhancement parameters for the high-resolution video stream, via the input control signal 560. Such enhancements may be devised to crop the video stream to accommodate a ROI having a higher resolution, and/or image quality adjustments and special effects.

It will be appreciated that the systems described herein are not limited to the embodiments described above. The components may be disposed on either the video capture device or the computing device, in a variety of arrangements. It is anticipated that those skilled in the art may device alternate arrangements for the components described above. For example, one may arrange the components in a manner that yields a desired video transfer rate in combination with a desired computer processing rate.

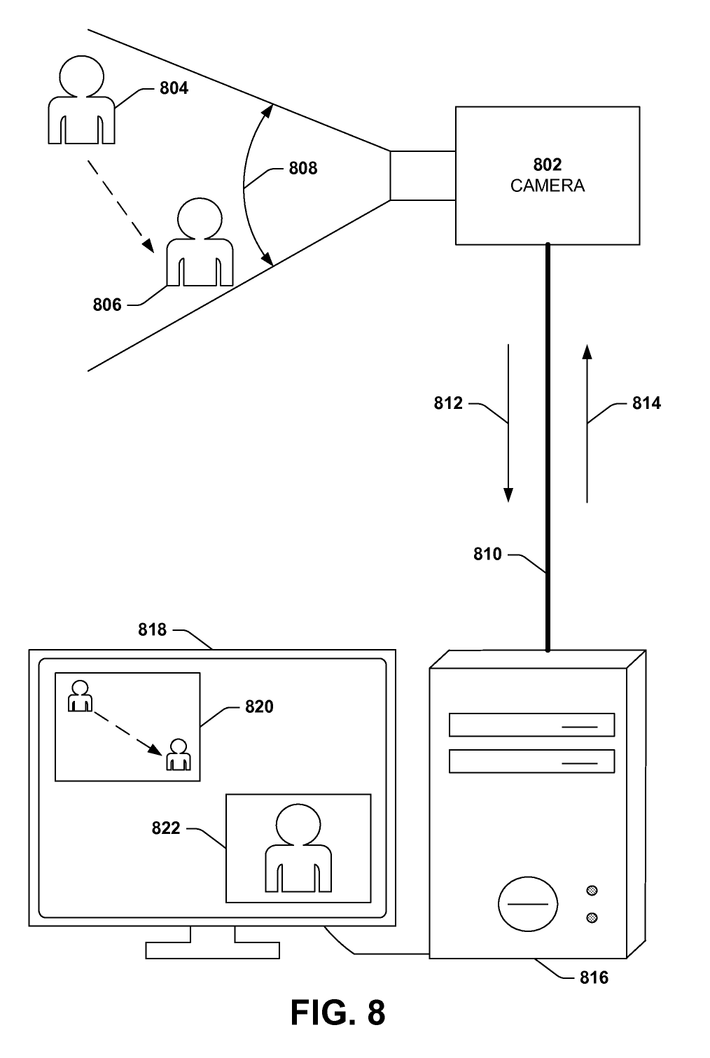

FIG. 8 is an illustration of an exemplary environment where the systems described herein may be used. A camera 802, such as a webcam, may be devised to capture an imaging area 808, such as a conference room during a video conference. An individual may be moving around the imaging area 808, such as from a position at 804 to a position at 806. Typically, during video conferencing, it may be desirable to focus on particular individuals in the imaging area 808.

Therefore, a low resolution video stream can be captured of the imaging area 808 by the camera, and sent 812 over a connection 810 to a computing device 816. A display 818 on the computing device can render the low resolution video stream 820, and a user may select a cropping area that corresponds to a desired high-resolution video stream for one or more objects/areas in the low-resolution video. For example, where the user wishes to merely view a face of an individual in the imaging area 808, the user can select that area of the low-resolution video that corresponds to the individual's face. In one embodiment, face recognition and tracking software may be used to track that individual's face as they move around the imaging area 808.

In this example, once a cropping area has been selected, and possibly other image enhancement parameters, these high-resolution video stream parameters can be sent 814 over the connection the video capture device, such as an input control signal, where a DSP may be used to process the high resolution video stream. In this way, the processed high-resolution video stream can merely comprise a cropped and enhanced portion 822 of the low-resolution video stream, which can be displayed on the computing device's display 818. Therefore, both a low-resolution and high-resolution video stream can be sent over the connection, which can allow for viewing a cropped high-resolution video that may comprise interesting detail, and viewing (or for processing) a low-resolution video that comprise the imaging area 808.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

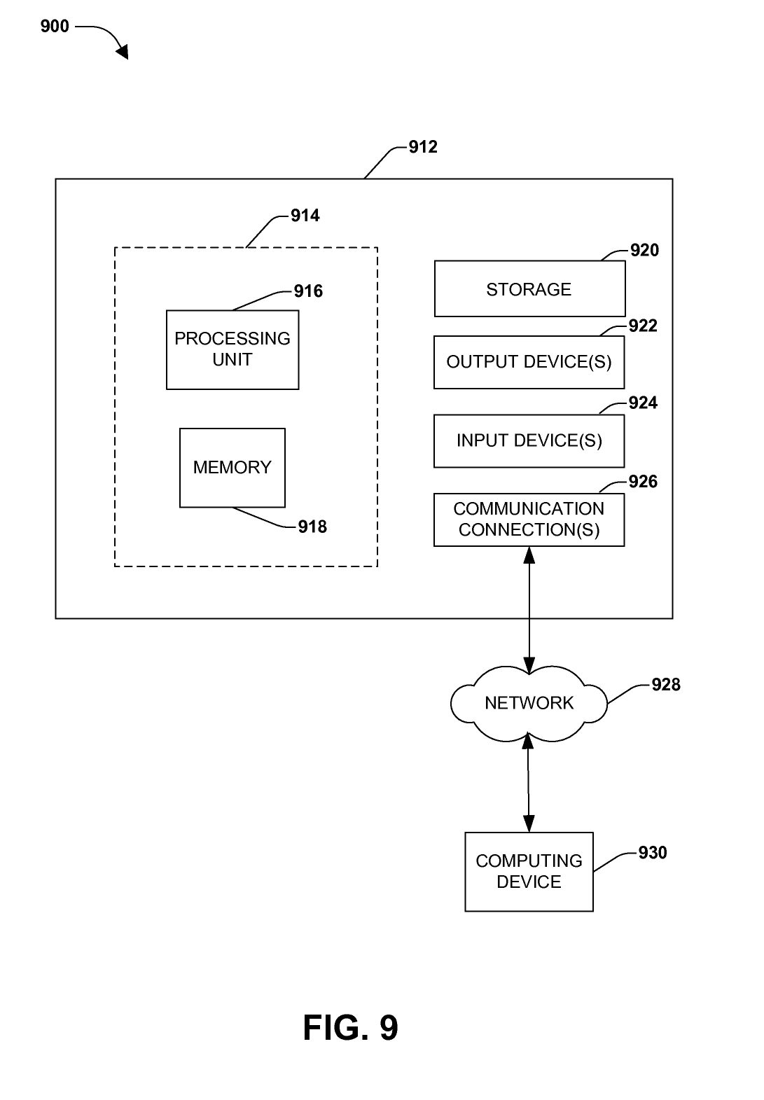

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system for providing improved transfer speed of video data from a video capture device to a computing device using multiple video feeds respectively comprising different resolutions, comprising:
a high-resolution image sensor configured to convert light images into a high-resolution video data stream;
a down sampler configured to convert the high-resolution video data stream to a low-resolution video data stream;
a digital signal processor (DSP) configured to process the high-resolution video data stream in accordance with an input control signal comprised of desired high-resolution video stream parameters derived from the low-resolution video data stream.

2. The system of claim 1, the high-resolution image sensor configured to convert light images into a high-resolution analog video data stream, and the system comprising an analog to digital processor (ADP) configured to convert the high-resolution analog video data stream to a high-resolution digital video data stream.

3. The system of claim 2, the ADP disposed on one of:
the high-resolution image sensor; and
the DSP.

4. The system of claim 1, the high-resolution image sensor comprising one of:
a charge-coupled device (CCD); and
a complimentary metal-oxide semiconductor (CMOS).

5. The system of claim 1, the down sampler disposed on the DSP.

6. The system of claim 1, comprising an input control signal generator configured to:
analyze the low-resolution video data stream; and
provide desired high-resolution video stream parameters based on input from one or more of:
pre-configured parameters for the input control signal generator; and
a user interface (UI) operably coupled to the input control signal generator and configured to allow a user to configure parameters for the high-resolution video stream.

7. The system of claim 1, the high-resolution video stream parameters comprising parameters for a cropping window that comprises a region of interest (ROI) from the low-resolution video data stream.

8. The system of claim 6, comprising an image processing component operably coupled to the input control signal generator, and configured to analyze the low-resolution video data stream to determine image enhancement parameters for the high-resolution video stream.

9. The system of claim 6, comprising a bandwidth coordination component operably coupled to the input control signal generator, and configured to:
identify a bandwidth of data transfer between the video capture device and the computing device; and
determine high-resolution video stream parameters that facilitate transferring a high-resolution video stream ROI to the computing device in accordance with the identified bandwidth.

10. The system of claim 6, the input control signal generator disposed on the video capture device.

11. A system for providing improved transfer speed of video data from a video capture device to a computing device using multiple video feeds respectively comprising different resolutions, comprising:
a light beam splitter configured to divide an incoming light beam into two or more fractions of the incoming light beam;
a high-resolution image sensor configured to convert light images from the beam splitter into a high-resolution video data stream;
a low-resolution image sensor configured to convert light images from the beam splitter into a low-resolution video data stream;
a digital signal processor (DSP) configured to process the high-resolution video data stream in accordance with an input control signal; and
an input control signal generator configured to generate the input control signal comprised of desired high-resolution video stream parameters derived from the low-resolution video data stream.

12. The system of claim 11, the respective image sensors configured to convert light images into an analog video data stream, and the system comprising one or more analog to digital processors (ADPs) configured to convert the analog video data stream to a digital video data stream.

13. The system of claim 12, the one or more ADPs disposed on one or more of:
the high-resolution image sensor;
the low-resolution image sensor; and
the DSP.

14. The system of claim 11, the respective image sensors comprising one of:
a charge-coupled device (CCD); and
a complimentary metal-oxide semiconductor (CMOS).

15. The system of claim 11, comprising an input control signal generator configured to:
analyze the low-resolution video data stream; and
provide desired high-resolution video stream parameters based on input from one or more of:
pre-configured parameters for the input control signal generator; and
a user interface (UI) operably coupled to the input control signal generator and configured to allow a user to configure parameters for the high-resolution video stream.

16. The system of claim 11, the high-resolution video stream parameters comprising parameters for a cropping window that comprises a region of interest (ROI) from the low-resolution video data stream.

17. The system of claim 15, comprising an image processing component operably coupled to the input control signal generator, and configured to analyze the low-resolution video data stream to determine image enhancement parameters for the high-resolution video stream.

18. The system of claim 15, comprising a bandwidth coordination component operably coupled to the input control signal generator, and configured to:
identify a bandwidth of data transfer between the video capture device and the computing device; and
determine high-resolution video stream parameters that facilitate transferring a high-resolution video stream ROI to the computing device in accordance with the identified bandwidth.

19. The system of claim 15, the input control signal generator disposed on the computing device.

20. A system for providing improved transfer speed of video data from a video capture device to a computing device using multiple video feeds respectively comprising different resolutions, comprising:
a high-resolution image sensor configured to convert light images into a high-resolution analog video data stream;
one of:
a down sampler configured to convert the high-resolution digital video data stream to a low-resolution digital video data stream; and
a light beam splitter configured to divide an incoming light beam into two or more fractions of the incoming light beam, and a low-resolution image sensor configured to convert light images from the beam splitter into a low-resolution analog video data stream;
an analog to digital processor (ADP) configured to convert the analog video data stream to a digital video data stream;
a digital signal processor (DSP) configured to process the high-resolution digital video data stream in accordance with an input control signal; and
an input control signal generator configured to:
analyze the low-resolution video data stream; and
provide desired high-resolution video stream parameters based on input from one or more of:
pre-configured parameters for the input control signal generator;
a user interface (UI) operably coupled to the input control signal generator and configured to allow a user to configure parameters for the high-resolution digital video stream; and
an image processing component configured to analyze the low-resolution video data stream to determine image enhancement parameters for the high-resolution digital video stream;
the high-resolution video stream parameters comprising parameters for a cropping window that comprises a region of interest (ROI) from the low-resolution digital video data stream.
